(19) United States
(12) Patent Application Publication
(10) Pub. No.: US 2010/0227250 A1
(43) Pub. Date: Sep. 9, 2010

(54) Rigidity & Inplane Electrolyte Mobility Enhancement for Fuel Cell Eletrolyte Membranes

(75) Inventors: Ru Chen, Portland, OR (US); Craig Evans, Portland, OR (US); Evan Rege, Portland, OR (US); Zakiul Kabir, Hillsboro, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: ClearEdge Power, Inc., Hillsboro, OR (US)

(21) Appl. No.: 12/397,158

(22) Filed: Mar. 3, 2009

(51) Int. Cl. H01M 4/00; H01M 2/00

(52) U.S. Cl. 429/483; 502/4; 429/535

(57) ABSTRACT

Embodiments related to fuel cells and membrane-electrode assemblies for fuel cells are disclosed. In one disclosed embodiment, a membrane-electrode assembly includes a catalyzed anode material and a membrane disposed in face-sharing contact with the catalyzed anode material. The membrane comprises mutually interpenetrating first and second phases, the first phase supporting an ionic conduction through the membrane, and the second phase supporting a dimensional structure of the membrane. The membrane-electrode assembly also includes a catalyzed cathode material disposed in face-sharing contact with the membrane, opposite the catalyzed anode material. Two opposing flow plates are also provided, each flow plate configured to distribute a reactant gas to a catalyzed electrode material of the membrane-electrode assembly. Other embodiments provide variants on the membrane-electrode assembly and methods to make the membrane-electrode assembly.

### BACKGROUND

Some fuel cells include a membrane-electrolyte assembly (MEA), in which a substantially solid electrolyte membrane is bonded on both sides to catalyzed electrode materials, e.g. catalyzed carbon fiber paper or cloth. The membrane-electrode assembly may be disposed between opposing flow-field plates that supply reactant gases (hydrogen and air, for example) to the catalyzed electrode materials. The assembly may be held together via a compressive force applied to the flow-field plates, the compressive force being sufficient to increase electrical conduction at the interface of the electrode and the flow field plate. In addition, this compression provides a sealing function which may prevent the escape of the reactant gasses from their predetermined flow paths and may further prevent overboard leakage.

The flow-field plates, where they contact the membrane-electrode assembly, may be substantially planar, but may include a plurality of flow channels through which reactant gasses are distributed. Thus, the flow-field plates may have a structured topology, through which an inhomogeneous compressive force is applied to the electrolyte membrane. In addition, the catalyzed electrode materials themselves may have a structured topology on the microscale, further contributing inhomogeneity to the compressive force applied to the membrane.

At elevated temperatures present in some fuel cells, the inhomogeneous compressive force applied to the membrane-electrode assembly may cause the membrane to deform (i.e., to creep). Depending on conditions, membrane creeping may be observed to some degree even at relatively low temperatures. The effects of membrane creeping may range from minor losses in fuel cell performance to complete failure, wherein loss of membrane integrity may allow contact between the electrodes or mixing of reactant gasses.

The problem of membrane creeping has been addressed by including hard stops on the flow-field plates or elsewhere in the fuel cell. For example, a hard stop can take the form of a machined ridge formed on one or both of the flow-field plates or a gasket set between them. The hard stop may thus be configured to prevent the electrodes from approaching too closely and thereby exerting too great a compressive strain on the electrolyte membrane. By limiting the compressive force between the electrodes and the electrolyte membrane, however, the hard stop may reduce the microscopic contact between a bipolar plate and an electrode, resulting in greater electrode overpotentials and/or greater internal resistance in the membrane-electrode assembly.

### SUMMARY

Accordingly, various embodiments are disclosed herein related to avoiding creep in a fuel cell membrane. For example, one disclosed embodiment provides a fuel cell, comprising a membrane-electrode assembly. The membrane-electrode assembly includes a catalyzed anode material and a membrane disposed in face-sharing contact with the catalyzed anode material. In this embodiment, the membrane comprises mutually interpenetrating first and second phases, the first phase supporting an ionic conduction through the membrane, and the second phase supporting a dimensional structure of the membrane. The membrane-electrode assembly also includes a catalyzed cathode material disposed in face-sharing contact with the membrane, opposite the catalyzed anode material. Two opposing flow plates are also provided, each flow plate configured to distribute a reactant gas to a catalyzed electrode material of the membrane-electrode assembly.

It will be understood that the summary above is provided to introduce in simplified form a selection of concepts that are further described in the Detailed Description. It is not meant to identify key or essential features of the claimed subject matter, the scope of which is defined uniquely by the claims that follow the Detailed Description. Further, the claimed subject matter is not limited to implementations that solve any disadvantages noted above or in any part of this disclosure.

### BRIEF DESCRIPTION OF THE DRAWINGS

FIG. 1 is a schematic exploded view of an embodiment of a fuel cell in accordance the present disclosure.

FIG. 2 schematically shows two example embodiments of fuel cell flow plate in accordance with the present disclosure.

FIG. 3 is a schematic representation of an embodiment of a membrane-electrode assembly in accordance with the present disclosure.

FIG. 4 shows a highly stylized, theoretical, sectional view of an embodiment of a membrane in accordance with the present disclosure.

FIG. 5 is a flow chart showing an embodiment of a method to make a membrane-electrode assembly in accordance with an embodiment of the present disclosure.

### DETAILED DESCRIPTION

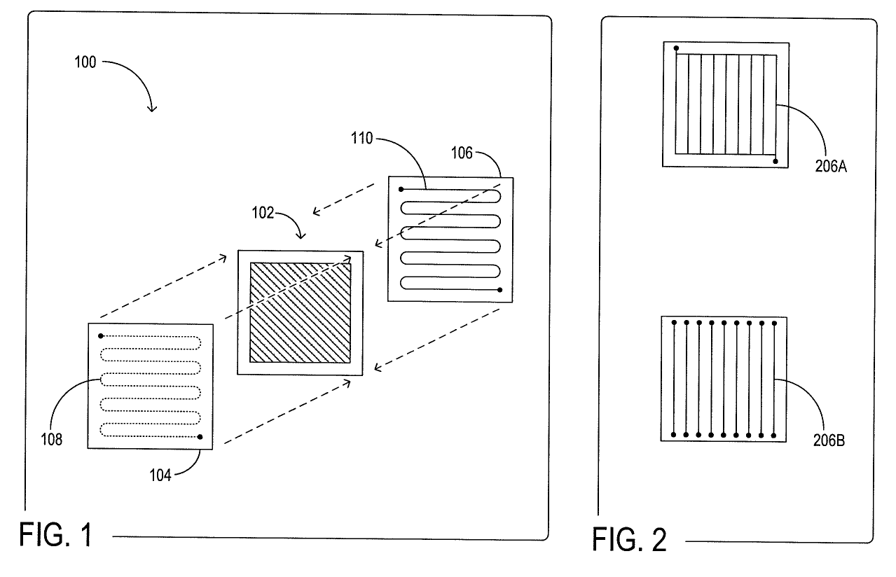

FIG. 1 shows an exploded view of an example embodiment of a fuel cell 100. The illustrated fuel cell 100 is a polymer-electrolyte membrane (PEM) fuel cell; it includes membrane-electrode assembly 102, anode flow plate 104, and cathode flow plate 106.

The anode and cathode flow plates, 104 and 106, each include a flow channel through which a reactant gas is distributed, and through which one or more reaction products may be removed. Thus, in the illustrated embodiment, anode flow plate 104 includes anode flow channel 108, and cathode flow plate 106 includes cathode flow channel 110. In one, non-limiting embodiment, hydrogen, humidified hydrogen or another fuel may be distributed via anode flow plate 104, air may be distributed via cathode flow plate 106, and water, in liquid and/or vapor forms, may be removed also via the anode and/or cathode flow plate.

In some embodiments, the flow channels may be formed in the flow plates by machining. In other embodiments, they may be formed via lamination, lithography, etching, or by any other suitable technique. In the illustrated embodiment, anode flow plate 104 and cathode flow plate 106 each include a serpentine flow channel, but flow channels of other geometries are contemplated as well.

Thus, in FIG. 2, parallel branching flow channel 206A and manifold-fed flow channel 206B are included to illustrate other example geometries. In embodiments such as those described above, one or both of an anode flow plate and a cathode flow plate may be substantially planar, but may have an inhomogeneous topology due to the flow channel or channels included therein.

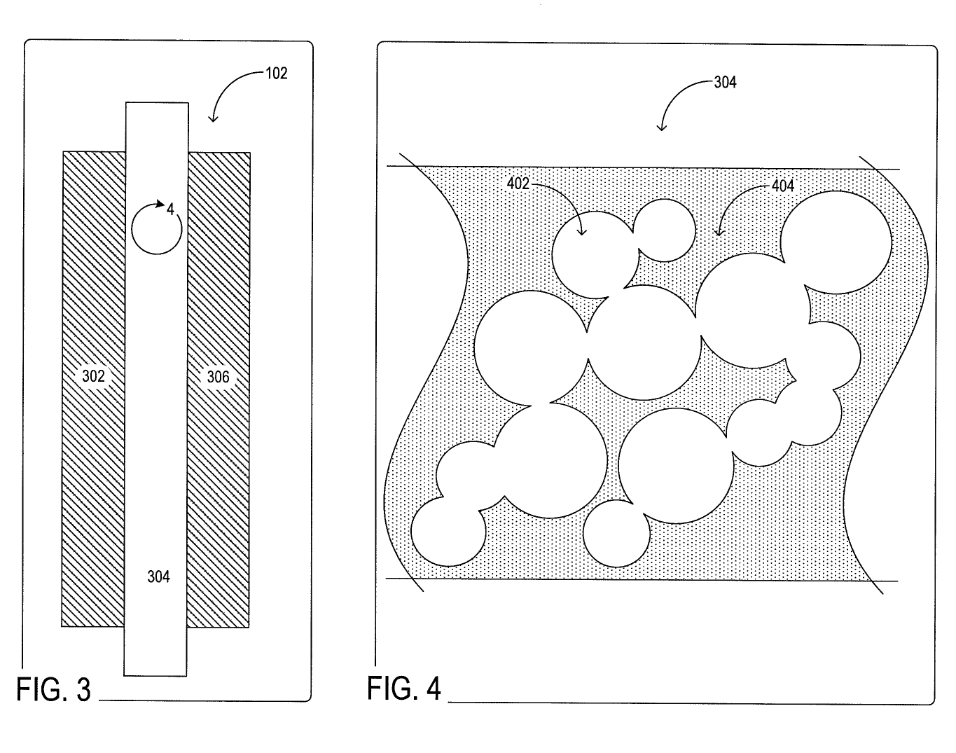

FIG. 3 shows example membrane-electrode assembly 102 in greater detail. In the illustrated embodiment, membrane-electrode assembly 102 includes catalyzed anode material 302, membrane 304 disposed in face-sharing contact with the catalyzed anode material, and catalyzed cathode material 306 disposed in face-sharing contact with the membrane, opposite the catalyzed anode material. Fuel cell 100 is assembled with membrane-electrode assembly 302 sandwiched between anode flow plate 304 and cathode flow plate 306, each of the opposing flow plates configured to distribute a reactant gas to a catalyzed electrode material of the membrane-electrode assembly.

In the assembled state, the two opposing flow plates may together exert an inhomogeneous compressive force on the membrane-electrode assembly because of an inhomogeneous topology of at least one of the two opposing flow plates. As described hereinafter, the membrane may be configured to substantially maintain its dimensional structure when the inhomogeneous compressive force is applied to the membrane-electrode assembly. A membrane having this property may be particularly useful in fuel cells such as the one shown in FIG. 1, where the two opposing flow plates are disposed in direct contact with the membrane-electrode assembly, absent an intervening hard stop (vide supra) configured to limit the compressive force exerted on any area of the membrane-electrode assembly.

FIG. 4 shows a highly stylized, theoretical, sectional view of example membrane 304 in microscopic detail. The membrane comprises mutually interpenetrating first and second phases, i.e., material phases of different and substantially constant composition, neither mixing with each other to form a single, homogeneous phase (a solution) nor separating into layers. A sponge soaked with water is a common, macroscopic example of a system comprising mutually interpenetrating first and second phases. In this example, the sponge is one phase, and the water trapped within the pores of the sponge is another phase. Examples in which the pore structure is microscopic, not macroscopic like the sponge, include solvent-filled gels or sol-gels, e.g. silica sol gels.

Thus, some embodiments include first phase 402, which supports an ionic conduction through the membrane, and second phase 404, which supports a dimensional structure of the membrane. The second phase may be designed or selected in part for its structural rigidity. For example, the second phase may comprise a polymer or a network solid. In the illustrated embodiment, the second phase comprises an open-cell pore structure, and the first phase at least partly penetrates the pore structure to provide a conductive pathway through the membrane. For the purpose of providing significant ionic conduction through the membrane, it may be advantageous that the second phase have a significant porosity. For example, the second phase may have a porosity greater than 50 percent by volume.

It will be understood that the term ‘open-cell pore structure’ is used herein to refer to a porous cell structure in which at least some of the cells are open, i.e., not fully closed, such that fluidic communication among at least some of the cells is possible. It is not meant to exclude a structure having some fully closed cells as well.

In some embodiments, the ionic conduction of the first phase may comprise a proton conduction. A proton-conducting first phase may be appropriate for fuel cells wherein the catalyzed anode material is configured to oxidize hydrogen to protons, the membrane is configured to conduct protons, and the catalyzed cathode material is configured to reduce oxygen and protons to water.

In some embodiments one or both of the first phase and the second phase may comprise a polymer. In one, non-limiting example, the first phase may comprise a polybenzimidazole. It will be understood that ‘polybenzimidazole’ as used herein may include a substituted polybenzimidazole, i.e., a polymer comprising the polybenzimidazole backbone, but also including one or more functional or non-functional substituents, side-chains and the like. It will further be understood that ‘polybenzimidazole’ may refer to polymers or mixtures of polymers having substantially different molecular weight distributions, tacticities, and the like.

In one series of embodiments, the second phase may comprise an expanded polytetrafluoroethylene (ePTFE). ePTFE is a commercially available membrane material formed from PTFE resin via extrusion and thermal elongation processes.

In another series of embodiments, the second phase may comprise a network solid, or solid particles held together by a binder, i.e., a material whose atoms are bonded together in two or three dimensions. Thus, in one, non-limiting example, the second phase may comprise a porous, silicon carbide containing ceramic.

In some embodiments, one phase (either the first phase or the second phase) may take the form of a host membrane; viz., it may be formed into a membrane having an open-cell pore structure. Within the pores of the host membrane, the other phase (either the second phase or the first phase) may be accommodated as a guest. Further, the guest may be a guest polymer, e.g. a polybenzimidazole. The resulting composite membrane is referred to herein as a guest-host membrane.

Further, in some embodiments, the guest-host membrane may include a modifier, i.e., compound or material intended to modify a property of the first phase and/or the second phase. For example, the modifier may be aqueous phosphoric acid, which is intended to increase proton conduction through a polybenzimidazole first phase. In other examples, the modifier may be a swelling agent, a wetting agent, or agent used to sequester unwanted trace constituents from the first phase or from the second phase.

Note that when a single-phase polymer membrane is used in a fuel cell membrane-electrode assembly, as opposed to an interpenetrating two-phase structure as disclosed herein, the single polymer phase acts to provide both ionic conduction and structural rigidity. This may be prove a significant limitation in designing or selecting a membrane, as a more ionically conductive polymer may be less rigid, and vice versa. An advantage of the guest-host membrane approach described herein is that the guest polymer may be optimized for ionic conduction while the host membrane may be optimized for structural rigidity. Thus, even though various issues must still be considered in designing or selecting mutually compatible phases, the present approach may offer an increased number and quality of membrane options.

Further, by imparting sufficient rigidity to the membrane-electrode assembly via the host membrane, creep due to an inhomogeneous compressive force of the fuel cell flow plates may be lessened or avoided. Thus, some contemplated embodiments may omit hard stops on the flow field plates for increased manufacturing simplicity, reduced costs, and better membrane/electrode/flow plate contact.

In one particular, non-limiting embodiment of a membrane comprising a proton conducting first phase (e.g., a polybenzimidazole) and rigidity-enhancing second phase, the first phase also comprises a phosphoric acid modifier. Such a membrane may be used in a high-temperature PEM fuel cell, for example. Unlike traditional phosphoric acid fuel cells, however, where the acid may be contained in a ‘matrix layer’ made of fine particulates of SiC, this polybenzimidazole-based membrane holds acid within the proton conducting first phase. This approach may simplify the processing and handling of the PEM fuel cell and lower the manufacturing cost.

A disadvantage of such a membrane, however, is the tendency of the phosphoric acid modifier to segregate during operation of the fuel cell. In particular, temperature gradients within the PEM membrane of the operating fuel cell may cause the volatile modifier to migrate from the warmer areas and to accumulate in the cooler areas. An appropriate amount of phosphoric acid in all areas of the membrane may be desired, however, to avoid membrane dry out. Moreover, the formation of extensive acid-dry areas within the membrane may result in increased ionic polarization, and, if allowed to continue for an extended duration, may deform or degrade the membrane. Thus, the segregation of the phosphoric acid modifier—in addition to inhomogeneous compressive forces—may reduce the dimensional stability of some membranes, leading to cross over and other performance issues.

The inventors herein have found a way to overcome this particular disadvantage by selecting and deploying an appropriately structured second phase within the polybenzimidazole first phase. The appropriately structured second phase may be configured to wick phosphoric acid from one or more relatively acid-rich areas to one or more relatively acid-dry areas of the membrane. The wicking may occur via capillary action, for example. Thus, the second phase may be structured by incorporating therein one or more filamentous or capillary-like materials configured to transport phosphoric acid from a relatively acid-rich area to a relatively acid-dry area of the membrane. In some embodiments, the one or more filamentous or capillary-like materials may be hydrophilic or comprise a hydrophilic adsorbent. Such materials may include silicon carbide filaments, glass wool, asbestos, a filamentous protein or polymer, for example. In this manner, proper distribution of phosphoric acid in the membrane may be maintained, providing undegraded fuel cell voltage. In such embodiments, the structural rigidity of the membrane is enhanced by the innate rigidity of the second phase relative to the first phase (e.g., its resistance to deformation under inhomogeneous compressive forces) as well as the ability of the second phase to limit deformation of the first phase by reversing the segregation of phosphoric acid therein. These two effects work together for a combined advantage.

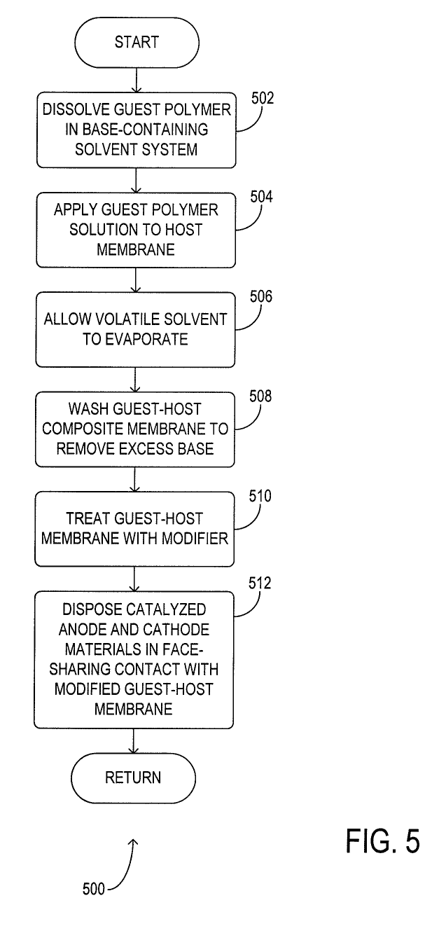

Turning now to FIG. 5, an example method 500 to make a membrane-electrode assembly is shown. The method begins at 502, where a guest polymer, e.g., a polybenzimidazole, is dissolved in a base-containing solvent system to yield a guest-polymer solution. In some embodiments, the solvent system may comprise a volatile alcohol component—methanol, ethanol, 2-propanol, as examples, and the base may be used to increase the solubility of the polymer in the solvent system. Bases suitable for this purpose include sodium hydroxide, potassium hydroxide, and aqueous ammonia, as examples. In other embodiments, polybenzimidazole may be dissolved in other solvents such as N,N-dimethyl acetamide, trifluoroacetic acid, methanesulfonic acid, and polyphosphoric acid.

The method continues to 504, where the guest-polymer solution is applied to a host membrane to yield a guest-host membrane. In one example, the host membrane may comprise an expanded polytetrafluoroethylene. In another example, the host membrane may comprise a porous, silicon carbide containing ceramic in the form of a membrane. The guest-polymer solution may be applied to the host membrane by soaking, spraying, painting, or by any other suitable technique.

The method continues to 506, where one or more volatile solvents included in the solvent system are allowed to evaporate from the guest-host membrane. A volatile solvent may be allowed to evaporate by leaving the guest-host membrane exposed to the atmosphere, by forcing air, purified air, or an inert gas to flow over the guest-host membrane, by evacuating a chamber in which the guest-host membrane is disposed, etc.

The method continues to 508, where the guest-host membrane is washed to remove excess base. If the base is soluble in water, then one or more water-soaking and/or water rinsing steps may be used to remove the excess base from the guest-host membrane. If the base is not soluble in water, soaking and/or rinsing with other solvents may be used instead.

The method continues to 510, where the guest-host membrane is treated with a modifier to yield a modified guest-host membrane. In some embodiments, the modifier may include aqueous phosphoric acid. In other embodiments, the modifier may include a swelling agent, a wetting agent, or agent used to sequester unwanted trace constituents from the first phase or from the second phase

Finally, the method arrives at 512, where a catalyzed anode material and a catalyzed cathode material are disposed in face-sharing contact with the modified guest-host membrane. In some embodiments, the catalyzed anode material and/or the catalyzed cathode material may be bonded to opposite faces of the modified guest-host membrane. It will be understood that in embodiments in which a modifier is not used, the catalyzed anode material and catalyzed cathode material may be disposed in face-sharing contact with—and in some embodiments bonded to—the guest-host membrane instead of a modified guest-host membrane.

It will be understood that some of the process steps described and/or illustrated herein may in some embodiments be omitted without departing from the scope of this disclosure. Likewise, the indicated sequence of the process steps may not be required to achieve the intended results, but is provided for ease of illustration and description. One or more of the illustrated actions, functions, or operations may be performed repeatedly, depending on the particular strategy being used.

Finally, it should be understood that the systems and methods described herein are exemplary in nature, and that these specific embodiments or examples are not to be considered in a limiting sense, because numerous variations are contemplated. Accordingly, the present disclosure includes all novel and non-obvious combinations and sub-combinations of the various systems and methods disclosed herein, as well as any and all equivalents thereof.

1. A membrane-electrode assembly comprising:
a catalyzed anode material;
a membrane disposed in face-sharing contact with the catalyzed anode material, the membrane comprising mutually interpenetrating first and second phases, the first phase supporting an ionic conduction through the membrane, and the second phase supporting a dimensional structure of the membrane; and
a catalyzed cathode material disposed in face-sharing contact with the membrane, opposite the catalyzed anode material.

2. The membrane-electrode assembly of claim 1, wherein the second phase comprises an open-cell pore structure, and the first phase at least partly penetrates the pore structure.

3. The membrane-electrode assembly of claim 2, wherein a porosity of the second phase is greater than 50 percent by volume.

4. The membrane-electrode assembly of claim 1, wherein the ionic conduction comprises a proton conduction.

5. The membrane-electrode assembly of claim 1, wherein one or both of the first phase and the second phase comprises a polymer.

6. The membrane-electrode assembly of claim 1, wherein the first phase comprises a polybenzimidazole.

7. The membrane-electrode assembly of claim 1, wherein the second phase comprises silicon carbide.

8. The membrane-electrode assembly of claim 1, wherein the second phase comprises an expanded polytetrafluoroethylene.

9. The membrane-electrode assembly of claim 1, wherein the catalyzed anode material is configured to oxidize hydrogen to protons, the membrane is configured to conduct protons, and the catalyzed cathode material is configured to reduce oxygen and protons to water.

10. The membrane-electrode assembly of claim 1, wherein the first phase comprises phosphoric acid.

11. The membrane-electrode assembly of claim 10, wherein the second phase comprises a filamentous or capillary-like material configured to transport the phosphoric acid from a relatively acid-rich area of the membrane to a relatively acid-dry area of the membrane.

12. A fuel cell comprising:
a membrane-electrode assembly, comprising: a catalyzed anode material; a membrane disposed in face-sharing contact with the catalyzed anode material, the membrane comprising mutually interpenetrating first and second phases, the first phase comprising phosphoric acid and supporting an ionic conduction through the membrane, the second phase supporting a dimensional structure of the membrane and comprising a filamentous or capillary-like material configured to transport the phosphoric acid from a relatively acid-rich area of the membrane to a relatively acid-dry area of the membrane; and a catalyzed cathode material disposed in face-sharing contact with the membrane, opposite the catalyzed anode material; and
two opposing flow plates, each flow plate configured to distribute a reactant gas to a catalyzed electrode material of the membrane-electrode assembly.

13. The fuel cell of claim 12, wherein the two opposing flow plates together exert an inhomogeneous compressive force on the membrane-electrode assembly because of an inhomogeneous topology of at least one of the two opposing flow plates, and the membrane is configured to substantially maintain the dimensional structure when the inhomogeneous compressive force is applied to the membrane-electrode assembly.

14. The fuel cell of claim 12, wherein the two opposing flow plates are disposed in direct contact with the membrane-electrode assembly, absent an intervening hard stop configured to limit the compressive force exerted on any area of the membrane-electrode assembly.

15. A method to make a membrane-electrode assembly, the method comprising: dissolving a guest polymer in a solvent system to yield a guest-polymer solution; applying the guest-polymer solution to a host membrane to yield a guest-host membrane; disposing a catalyzed anode material and a catalyzed cathode material in face-sharing contact with the guest-host membrane.

16. The method of claim 15, wherein the guest polymer comprises a polybenzimidazole.

17. The method of claim 15, wherein the solvent system comprises a volatile component, the method further comprising allowing the volatile component of the solvent system to evaporate after the guest polymer solution is applied to the host membrane.

18. The method of claim 15, wherein the solvent system comprises a base, the method further comprising washing the guest-host membrane to remove excess base from the guest-host membrane.

19. The method of claim 15, further comprising treating the guest-host membrane with a modifier.

20. The method of claim 19, wherein the modifier comprises phosphoric acid.

21. The method of claim 15, wherein the host membrane comprises an expanded polytetrafluoroethylene.

22. The method of claim 15, wherein the catalyzed anode material and the catalyzed cathode material are bonded to opposite faces of the modified guest-host membrane.
